(19) United States
(12) Patent Application Publication
(10) Pub. No.: US 2009/0231951 A1
(43) Pub. Date: Sep. 17, 2009

(54) Process and device for the preparation of mixtures

(75) Inventors: Heinz Hausmann, Leichlingen (DE); Juergen Fietz, Odenthal (DE)

Correspondence Address: BAYER MATERIAL SCIENCE LLC, 100 BAYER ROAD, PITTSBURGH, PA, 15205, US

(73) Assignee: Bayer MaterialScience AG, Leverkusen (DE)

(21) Appl. No.: 12/378,873

(22) Filed: Feb. 20, 2009

(30) Foreign Application Priority Data
Feb. 23, 2008 (DE) 10 2008 010 751.4

(51) Int. Cl. G05D 11/02

(52) U.S. Cl. 366/152.2

(57) ABSTRACT

The invention relates to a process and a device for the preparation of mixtures of liquids and/or solids, in particular for the preparation of polyol formulations for use in the preparation of polyurethanes.

The invention relates to a process and a device for the preparation of mixtures of liquids and/or solids, in particular for the preparation of polyol formulations for use in the preparation of polyurethanes.

Many branches of industry require the preparation of mixtures of various liquids and/or solids industrially according to variable recipes, e.g. in the foodstuff industry, the pharmaceutical industry, the petrochemical industry, the preparation of paints and lacquers or plastics mixtures. One of these branches is the preparation of polyol formulations for use in the production of polyurethanes. Here, most diverse mixtures, for which in turn hundreds of different recipes exist, have to be prepared from a large number of base components (polyols, blowing agents, stabilizers, activators, additives etc.). According to that a need for devices and processes with which mixtures can be prepared simply, effectively and in a timely manner.

Traditionally, for the preparation of a mixture according to a given recipe the corresponding amounts of the individual components are charged manually from storage containers and mixed. This operation is time and manpower consuming. Therefore various techniques have been developed in order to design the process more effectively. For the reduction of disadvantages associated with manual removal and weighing of individual recipe components from their storage containers, such as time consumption and measurement inaccuracy, automatic metering devices have been developed, which enable the removal of an adjustable amount of the particular component from the storage container.

Devices with which all the storage containers are connected via pipelines to a central stationary mixing vessel, into which the individual components of the particular recipe are metered via a suitable control, represent an additional simplification. A disadvantage of this variant is that in case of a relatively large number of individual components the design of the apparatus becomes very complicated and expensive.

Mixtures according to various recipes can be prepared only successively. To prepare two different mixtures at the same time, a second mixing device is necessary.

A mixing device in which the mixing container is transported on a conveyor belt past a number of stationary storage containers for the individual components is an alternative to the well known method. When the mixing container arrives at a storage container which contains a component listed in the recipe, it is metered into the mixing container. The device of the invention allows mixtures according to different recipes to be prepared simultaneously. It is a disadvantage however, that each mixing vessel necessarily approaches all storage containers, although a large number of these contain none of the components required for the particular recipe. Onwards transportation of all mixing containers can always only take place when the actual metering operation for all mixing containers is finished i.e. before the next step all have to wait for the slowest metering operation to be finished.

A process has now been developed with which mixtures can be prepared even more efficiently, and a device which is suitable for carrying out the process. In the process according to the invention, mixing containers which can be moved independently are involved. The individual mixing containers are moved as determined by recipe to one of several stationary storage containers for the components of the particular recipe. The amount of the particular component specified in the recipe is then metered into the particular mixing container. The mixing container is then moved to the storage container for the next component of the recipe, and the amount of the component specified in the recipe is metered into the mixing container. This procedure is carried out until all the components listed in the recipe are charged to the mixing container.

One advantage of the process is that several different recipes can be processed simultaneously. Due to the mixing containers which can be moved independently, waiting times are significally reduced. For example, if the metering operation requires a longer time for a certain mixing container, the other mixing containers can already proceed to the next step or the step after but one metering step at a time only. Mixtures which contain a smaller number of components can be processed much more quickly, in case no fixed mixing sequence is specified. It is possible at any time to start the preparation of an additional mixture according to another recipe.

The invention also describes a device for the preparation of mixtures of liquids and/or solids. The device according to the invention comprises of (1) several stationary storage containers with controllable metering devices, (2) one or more mixing containers which can be moved independently between the storage containers, and (3) means for controlling the mixing containers and the metering devices of the storage containers.

### BRIEF DESCRIPTION OF THE DRAWINGS

FIG. 1 is a diagram illustrating the means for controlling the mixing containers and the metering of materials to be fed to the mixing containers in one embodiment of the present invention.

FIG. 2 illustrates arrangements of the stationary storage containers with controllable metering devices, the movable mixing container and means for weighing the contents of that mixing container in one embodiment of the present invention.

### DETAILED DESCRIPTION

Preferably, the storage containers are equipped with electromechanically or pneumatically switchable metering valves, which are controlled electronically. Preferably, the storage containers are equipped with means for initiating the metering operation.

In a preferred invention, the mixing containers are dispatching vessels (for example hobbocks, drums or disposable containers (DC)) on mobile movable stands. Preferably, devices for weight measurement are integrated into the stands.

In a preferred embodiment of the invention, the metering devices of the storage containers and of the mixing containers are controlled by a central computer, preferably the control being particularly wireless, e.g. via WLAN.

The invention also provides for a process for the preparation of mixtures of liquids and/or solids, in particular of polyol formulations, in which a) a recipe for the mixture is selected, b) the recipe is assigned to a mixing container, c) a first component of the recipe is selected, d) the mixing container is moved to the storage container of the first component, e) the amount of the first component listed in the recipe is charged to the mixing container, f) another component of the recipe is selected, g) the mixing container is moved to the storage container of the new component, h) the amount of the new component listed in the recipe is charged to the mixing container, steps f to h being carried out as often as necessary until all components of the recipe have been charged to the mixing container. The mixture is optionally homogenized (e.g. by all kinds of mixers like static mixers, drum mixing units etc.), whereas the homogenization can be carried out after addition of all components or after each addition of a component or continuously too. Homogenization after addition of all components of the recipe is preferred.

One variant of the process according to the invention is that some of the components, for example those which are added to the mixture in small amounts only, are premixed separately in a second mixing vessel This mixture then is charged to the first mixing container.

In another preferred variant, the process is controlled via program-controlled computer, whereas in step a) a recipe is selected from a database and the desired amount of the mixture to be prepared is entered, in step b) the computer assigns this task to a mixing container, transmits to it in steps c) and f) information about (at least) the particular component to be introduced and the corresponding amount and the storage container which contains this component, and in steps e) and h) the computer starts the metering operation by activating the metering device of the storage container and, after charging the specified amount of the component to the mixing vessel, stops it. Action of the mixing container in steps d) and g) is controlled by the computer the same way. This control can be effected via remote-controlled motor-driven mixing containers or via a corresponding display on manually moved mixing containers which informs the operator of the mixing container of the next storage container to be approached. In the latter variant, it is advantageous to also provide for displays on the storage containers, indicating to the operator the next storage container to approach.

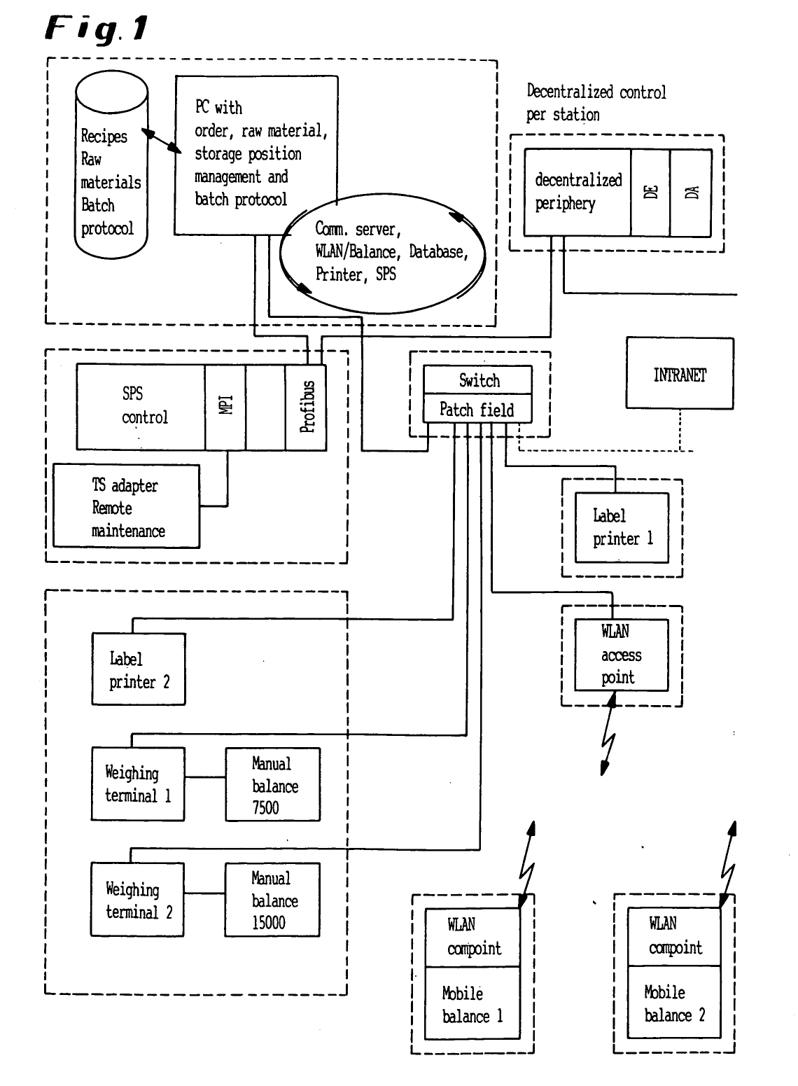

A particular design of the invention is described in the following example and is shown in diagram FIG. 1. The device comprises of various semiautomatic metering stations (modules), manual metering stations, mobile balances (weighing slides), communications server, database with recipe management and label printer (barcode), barcode scanner and WLAN access points.

### Semiautomatic Metering Station (Metering Modules)

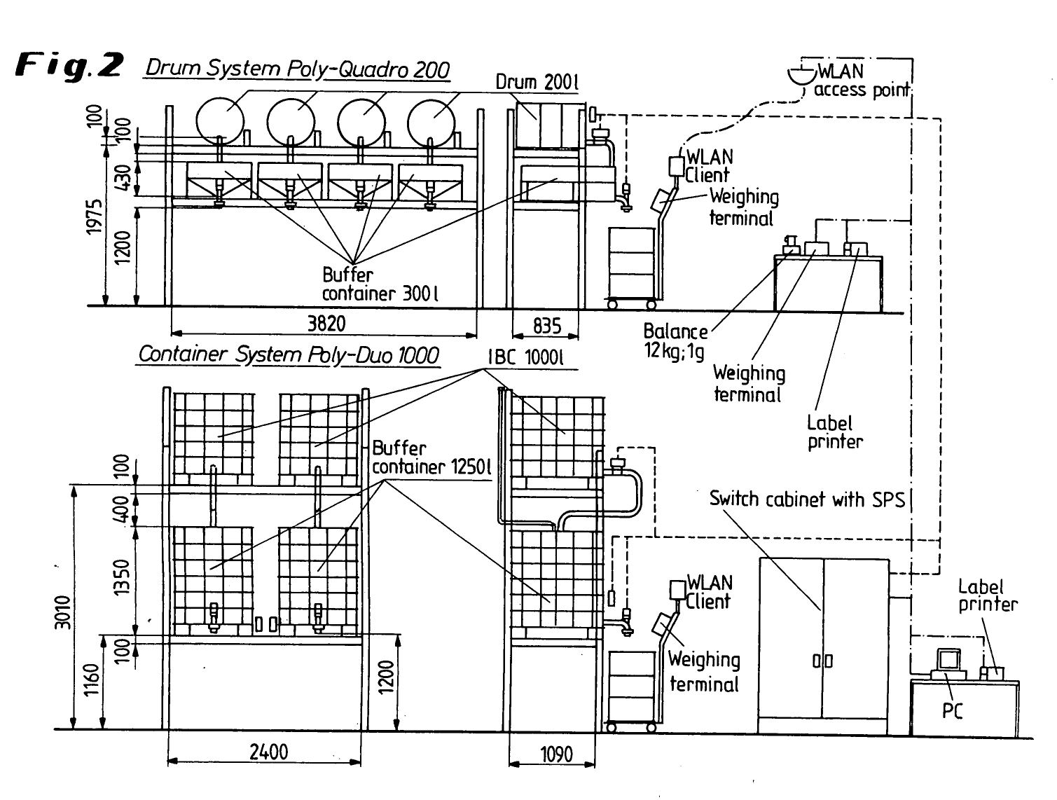

All modules have an adapter for the delivery container on top and a buffer container mounted underneath. FIG. 2 shows two possible variants of the module: as a drum system and as a container system. The buffer container is equipped with a top-up control, overflow safety device, gas displacement line and electro pneumatic 2-stage filling valve. Each module has an indicator light panel (colours assigned to the weighing slides), release button, preselection switch for manual or automatic operation and a ring exhaust close to the filling valve in addition. Before operation, a delivery vessel (e.g. 200 l drum or 1,000 l IBC) must be mounted and connected to the special module top-up control. The liquid is thereby transferred gravimetrically from the delivery vessel to the buffer container. The gas content of the buffer container is transferred back into the delivery vessel (closed system) simultaneously.

### Mobile Balances (Weighing Slides)

This type of balances consists of a frame on wheels on which the weighing platform is mounted. In addition all balances are equipped with an operator panel which guides the operator through processing of the recipe. W-LAN antennae and integrated communication units ensure transfer of data between the balance and the communications server. A battery takes care of the power supply. Each balance has a coloured identification which corresponds to one of the indicator lights on the metering modules.

### Manual Metering Stations

Smaller recipe ingredients can be metered via manual metering stations and a mobile balance, subsequently mixed and added to the remainder of the total recipe in the main vessel (drum or IBC). Therefore errors concerning the recipe cannot occur, and the masterbatch as well as the main vessel is provided with a barcode label. These labels are transferred to the PC by means of a scanner and are checked before the addition. The stations comprise of a buffer container and replaceable container, manual metering valve and various fittings. It has a gas displacement system and inert gas charging.

### Communications Server and Databases

This is the control centre of the entire unit. Recipes are stored, called up and processed by the database. In this context, the data are exchanged with the various weighing slides via the communications server. All the settings and parameters for the metering are stored in the database. The correct filling amounts as specified in the recipe are monitored, actual values are stored and appropriate switching operations (for example closing of the metering valves) are initiated via a connected SPS.

### Safety Devices

Overfilling of the drums is prevented by a max. weight input on the balance;
If over-/under-metering (outside the tolerance specified) of a component occurs, the computer issues an appropriate error message;
Incorrect products cannot be metered because of an internal electrical locking system;
During communication between server and balance, a “live bit” is also transmitted. If this bit is absent (for example due to an empty balance battery), the filling valve closes and the unit goes into malfunction mode;
If no increase by weight is recorded by the balance during metering, the metering operation stops immediately;

Various polyol recipes are formulated “semiautomatically” in the vessel using the device. This process is assisted by a recipe and metering program database and a communications server. The weight is recorded by means of mobile platform balances (weighing slides) which are in continuous communication with the recipe program and downstream databases via WLAN and access points.

### Processing an Order (Example):

An empty vessel is first positioned on a weighing slide. The operator retrieves a formulation order from the operator panel of a weighing slide. A barcode is first generated for this order, printed and glued on to the empty vessel (later identification). Then the operator starts processing the order. The OP (operator panel) indicates the first metering position to him (e.g. row 1 position 4). An indicator light (continuous light) of the corresponding metering module assists the operator in finding the correct metering position. The colour of the indicator light corresponds to the colour of the weighing slide. When the vessel to be filled is positioned with its filling neck exactly under the filling valve, semiautomatic transfer of a raw material compound takes place according to the recipe stored. For this to happen, the operator first pushes the button on the OP of the weighing slide, and shortly thereafter the release button on the corresponding metering module.

After the computer has checked that the correct balance is standing in the correct metering position, the computer starts the metering operation via SPS and opens the filling valve. When the major quantity is dosed, the filling valve switches into “fine stream” (smaller cross-section of the valve). After having charged the specified amount, the filling valve is closed and the metering of the component is finished. The information concerning the particular weight is received by the computer from the balance via WLAN. The operator can take care of other formulations and orders after the “start” of the metering (parallel processing), since the switching operations are processed automatically. When the filling operation is finished, the indicator light on the metering module flashes and indicates to the operator that the next component can now become charged. The operator now exits the metering on the operating unit (OP) on the weighing slide. Then the next component is displayed. Simultaneously, the corresponding indicator light lights up on the next metering module. This operation is repeated with various raw materials until the recipe stored is fully “processed”. The end of the charging process is indicated to the operator by a message on the OP. When the semiautomatic metering has come to an end, smaller amounts (additives) can be added manually to the vessel, if appropriate.

Components with relatively small amounts by weight are charged separately in a masterbatch process with manual metering modules and are added to the main vessel at the very end of the process, since balances with higher resolution are required for this particular process. The process is very similar to the process of the metering described above. Processing of the recipe is assisted by the computer and WLAN-controlled balances the same way. Nevertheless, metering of the individual components is a purely manual operation. After charging the components of the masterbatch, the “masterbatch” is premixed. Before addition to the main vessel, the barcode of the “masterbatch” is compared with that of the main vessel by means of a scanner. If both match, blending will be done, and the batch in the main vessel is homogenized and a sample submitted for testing.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Device for the preparation of mixtures of liquids and/or solids, comprising
(1) several stationary storage containers with controllable metering devices,
(2) one or more mixing containers which can be moved independently of one another between the storage tanks, and
(3) means for controlling the mixing containers and the metering devices of the storage containers.

2. Process for the preparation of mixtures of liquids and/or solids, in which
a. a recipe for the mixture is selected
b. the recipe is assigned to a mixing container
c. a first component of the recipe is selected
d. the mixing container is moved to the storage container of the first component
e. the amount of the first component envisaged in the recipe is introduced into the mixing container
f. a further component of the recipe is selected
g. the mixing container is moved to the storage container of the further component
h. the amount of the further component envisaged in the recipe is introduced into the mixing container,
steps f to h being carried out as often as necessary until all the components of the recipe have been introduced into the mixing container.
